(19) United States
(12) Patent Application Publication
(10) Pub. No.: US 2008/0225422 A1
(43) Pub. Date: Sep. 18, 2008

(54) Optical Filter

(75) Inventors: Peter-Andre Redert, Eindhoven (NL); Bartolomeus Wilhelmus Damianus Van Geest, Eindhoven (NL); Dirk Jan Broer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/066,678

(22) PCT Filed: Aug. 29, 2006
(86) PCT No.: PCT/IB06/52994

§ 371 Date: Mar. 13, 2008

(30) Foreign Application Priority Data
Sep. 15, 2005 (EP) 05108490.3

(51) Int. Cl. G02B 5/22

(52) U.S. Cl. 359/885

(57) ABSTRACT

An optical filter for filtering light rays having mutually different light intensity and direction of incidence on the optical filter along a number of mutually different directions and having a predetermined wavelength or wavelengths, has a carrier body which is transmissive for light rays having the predetermined wavelength or wavelengths and a plurality of photo-adaptive light-blocking elements distributed within the carrier body rendering the optical filter least transmissive in the direction along which the light ray having the highest light intensity is incident.

This invention relates to an optical filter for filtering light rays incident on the optical filter along a number of mutually different directions and having a predetermined wavelength or wavelengths, a method of manufacturing such an optical filter and to the use of such a filter.

Bright light sources as the sun may impair good vision in many applications, such as walking, looking through a window, driving, watching TV etc. In some cases it is the direct effect of the bright light source that causes the problem, e.g., when a driver gets blinded by the sun directly and in other cases it is the indirect effect of the sun, or another bright light source, that distorts the visibility in some way, e.g., when reflections occur in a display screen.

The above examples have been addressed in prior-art with various devices depending on the specific problem. One example is sunglasses comprising photochromic elements, homogeneously distributed in the glass material, having a luminous transmission which changes in a reversible manner as a function of the exposure of the glass to a source of radiation. When bright light is shone onto the glasses the photochromic elements in the glass, or in a coating covering the glass, will change its optical properties, transmitting only a fraction of the bright light.

There is, however, an inherent problem with these prior-art glasses in that, though they change their properties in relation to the ambient light conditions, in each specific situation they do not work better than glasses containing e.g. dispersed carbon black particles. This is because the total amount of the photochromic elements, homogeneously distributed in the glass, will react to the bright light, each element moderately attenuating the light, thus darken the glass homogeneously. Also, for the very same reason, the blocking of bright light cannot be complete since that would imply that also light scattered from all other objects would be attenuated, which needless to say is an undesired feature. Consequently, as soon as there is a bright light source present, the prior-art glasses will reduce the visibility of other objects by relatively the same amount as the visibility of the bright light source is reduced.

U.S. Pat. No. 4 746 633 enclose a summary of the state of the art related to photochromic substrates that can darken to a comfort range, i.e., below 35-60%, or to a dark range, i.e., below 35%.

U.S. Pat. No. 6,244,703 discloses a personal glare reduction device having a darkened spot which can be moved in a position where it covers the location of a glare source; detection of glare and movement is done by means of light sensors and data processor unit.

An object of the present invention is hence to overcome drawbacks related to prior art optical filters.

These and other objects are achieved by an optical filter for filtering light rays of a predetermined wavelength or wavelengths and having mutually different light intensity and direction of incidence on the optical filter, the optical filter comprising a carrier body which is transmissive for light rays having the predetermined wavelength or wavelengths and a plurality of photo-adaptive light-blocking elements distributed within the carrier body rendering the optical filter least transmissive in the direction along which the light ray having the highest light intensity is incident.

The invention relates to an optical filter that modifies its light-transmissive properties in response to the direction and light intensity of the light rays incident on the filter. To this effect, the light-blocking elements are photo-adaptive, meaning that the light-blocking elements change the extent to which they transmit light in response to the intensity of light incident thereon. The wavelengths of the light for which the transmission is changed are not necessarily the same as the wavelengths of the light which cause the change in transmission. The change in transmission can be realized by a change in scattering, reflection or, preferably, absorption. Preferably, the changes in transmission are reversible. Photochromic light-blocking elements are examples of such reversibly photo-adaptive light-blocking elements.

As will be explained more in detail hereinbelow, the optical filter is directionally photo-adaptive because the light-blocking elements are discrete elements, preferably at random, distributed within the transparent carrier body.

The directionally photo-adaptive properties of the optical filter are improved if the extent to which the light-blocking elements block light relative to that of the carrier body increases.

Preferably, the light-blocking ability of the light-blocking elements is such that one such element is sufficient is to block substantial all the light incident on such element along a direction of highest light intensity having as result that further light-blocking elements along said direction but further away from the light source are not activated because not sufficient light is incident thereon.

However, more stringently, the extent to which a light-blocking element blocks light is may be expressed in terms of transmitted light energy as a function of incident light energy, i.e. OUT=f(IN): OUT=IN for IN<L, and somewhere in the interval [0, L] for IN>L, where L is a desired limit on the strength of the attenuation. In this case, very bright light above the limit L is limited by the first light-blocking element encountered.

When the value L is selected within the interval, the light-blocking element is a hard limiter. The bright light is then dimmed, but still visible at the desired intensity limit. If the value zero is chosen within the interval, the object emitting bright light (e.g. sun) will appear black.

In practice a curve corresponding to the above function will flatten beyond the limit L, but not so fast as desired, e.g. via a square root or logarithmic curve, that keeps increasing after limit L, but slowly. In that case, there will be some light above limit L passing the first element encountered, which will affect the second element encountered, leading to slightly additional dimming of other, non-bright objects.

As in practice photo-adaptive elements have some time constant, the above function OUT=f(IN) represents only the steady-state behavior. That is, the steady state after a time corresponding to several element-time-constants has passed.

Consequently, using the optical filter in accordance with the invention, the transmission of bright light emitting objects can thus, automatically and without complex equipment, be severely reduced while light emanating from other objects can pass without nearly as much absorption. As can be easily understood these features are highly attractive in several areas where selective absorption of bright light is a wanted feature.

According to a preferred embodiment the light-blocking elements are randomly distributed. This is a desired feature since it in many cases simplifies the manufacture of the substrate. Nevertheless, a more regular distribution is also feasible.

The light-blocking elements preferably occupy about 0.05 to 50%, or better still, about 0.5 to 15% of the combined volume of the carrier body and light-blocking elements.

The light-blocking elements can have any shape but are conveniently selected to be essentially spherical.

The elements may have a largest dimension or, in case of a spherical element radius in the order of 0.5-500 μm, preferably in the order of 5-50 μm. To be perceivable as discrete elements, the elements should have a dimension or radius which is at least several times the wavelength of the light to be blocked. The use of relatively well-defined essentially spherical light-blocking elements makes the properties of the optical filter predictable and simplifies manufacture. Nonetheless, the spherical shape is not essential, and other shapes as cubes or less regular shapes are also possible, as long as light-blocking elements can remain inactivated because of being shadowed by activated light-blocking elements closer to the light source which activated the closer element.

The light-blocking elements preferably are photochromic, i.e. comprise a photochromic component. The function of the light-blocking elements is to alter the incoming bright light in a way that facilitates the blocking of the light. The use of photochromic components is an efficient and commercially available way of achieving this. The photochromic component is preferably loaded into the essentially spherical light-blocking elements. Conveniently the spherical element is made of a transparent polymer such as polymethyl(meth)acrylate. Thus, the size and light-blocking properties of the light-blocking elements can be controlled effectively in a simple manner.

A method of manufacturing an optical filter in accordance with the invention, comprises the steps of:
providing a first quantity of first transparent particles;
providing a second quantity of second transparent particles containing photo-chromic material and mixing said first and second particles, the second quantity being substantially less than the first quantity;
molding the mixture of first and second particles into a shape resembling that of the carrier body;
while maintaining the shape of the shaped mixture of first and second particles, immersing the shaped mixture of first and second particles into a curable liquid having, in its cured state, a refractive index which matches that of the first particles;
while maintaining the shape of the shaped mixture of first and second particles, curing the curable liquid.

The method in accordance with the invention allows optical filters in accordance with the invention having high transparency and opacity to be manufactured in a simple manner.

Preferably, the particles are spherical to allow for dense packing. Polymer particles such as polymethylmethacrylate particles are preferred.

In a particular embodiment, the shaped mixture of first and second particles is molded against the surface of a product with which the optical filter is to be combined.

This provides for an efficient way of applying the optical filter onto an product even if the product has a non-planar surface. Curing is convenient if the liquid is photo-curable and the curing is performed using ultraviolet light. Curing may be done using a mold more particular a (partially) UV transparent mold.

The optical filter in accordance with the invention can be used for several applications and devices where attenuation of bright light is a desired feature. The device could be one of: a windshield, a window, a display unit, eyewear but the person skilled in the art will appreciate that are just that, examples.

The invention will be more fully understood in the following where it is described in the form of non-limitative embodiments, referring to the accompanying drawings, of which:

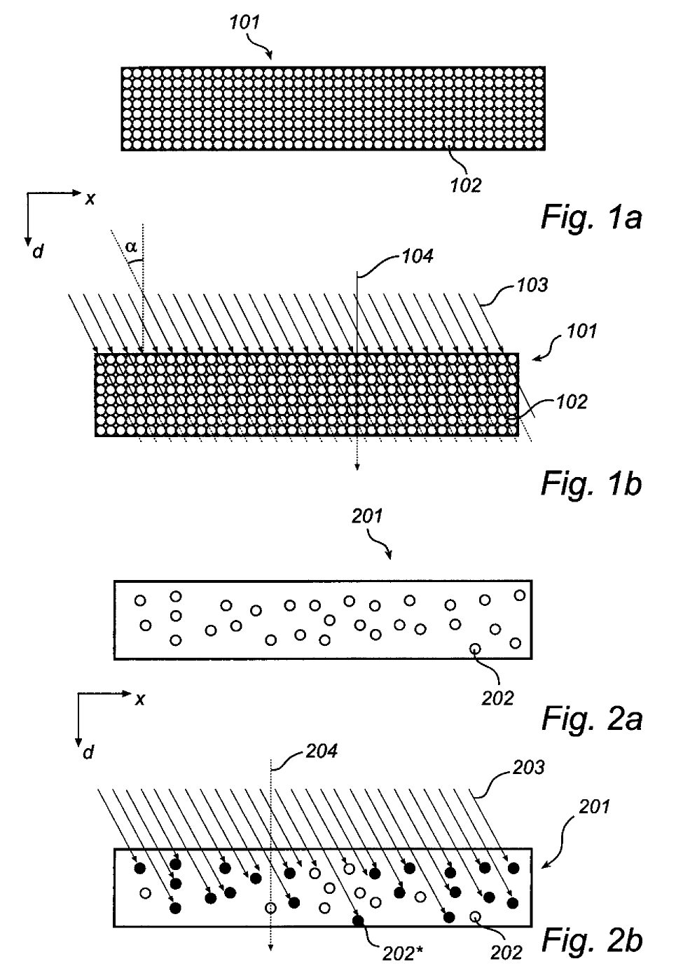

FIGS. 1a and 1b are schematic cross-sectional views of a prior art optical filter in a non-illuminated and an illuminated state, respectively;

FIG. 2a is a schematic cross-sectional view of an optical filter in accordance with the invention in an inactivated, non-illuminated state;

FIG. 2b is a schematic view of the optical filter in FIG. 2a in an activated, illuminated state;

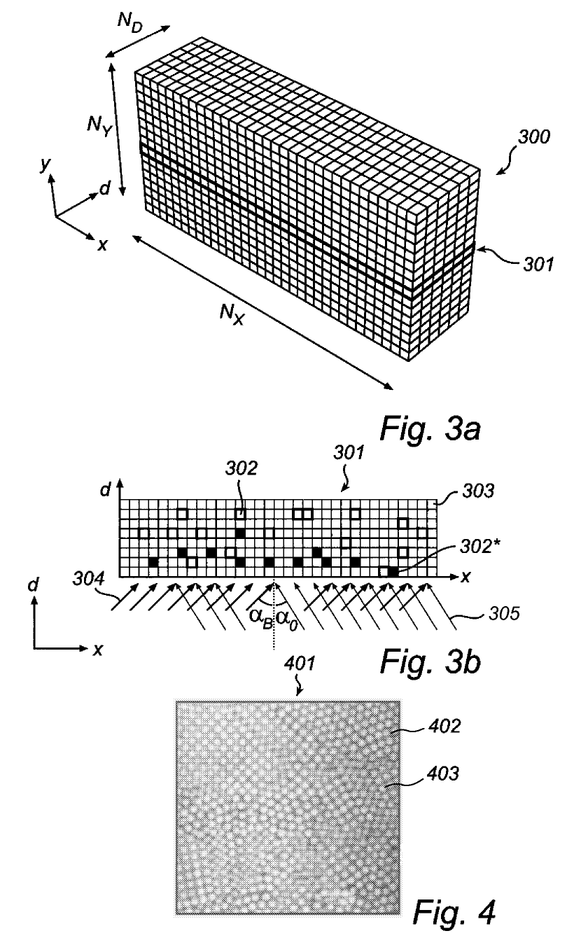

FIG. 3a is an illustration of a compartmentalization of an optical filter in accordance with the invention;

FIG. 3b shows a slice of the compartmentalized optical filter shown in FIG. 3a; and

FIG. 4 shows a packing of spherical polymer particles.

Turning now to FIGS. 1a and 1b, in which a prior art optical filter is illustrated comprising a carrier body 101, in the form of a sheet or layer, wherein light-blocking elements in the form of photochromic elements 102 are homogeneously distributed. The substrate extends in x-d direction as indicated. The coordinate axes are consistent for all figures. The direction normal to the main surface of the substrate is indicated by d, and x indicates the axis at a right angle to d in the 2-dimensional case.

When subjected to rays of bright light, indicated by the solid arrows 103 incident from an angle α relative to the d direction, the photochromic elements 102 become more absorbing. Because the photochromic elements 102 are homogeneously distributed in the carrier body, the optical filter 101 darkens homogeneously along the direction x. The consequence is that other rays, indicated by a dashed arrow 104, are attenuated relatively by the same amount.

Turning now to FIGS. 2a and 2b, an optical filter 201 according to the invention will be described. The optical filter 201 comprises photo-adaptive elements 202. The elements 202 are distributed in a manner such that the incident bright light, indicated by solid arrows 203 incident at an angle α relative to the d direction will hit on what appears to be a continuous “wall” of elements 202 that potentially could be activated. In this example, the photo-adaptive properties of the photochromic elements 202 are selected such that the incident bright light rays 203 only activate the first photo-adaptive element 202 each encounters. In its activated form each photochromic element, activated photochromic elements indicated by reference sign 202*, attenuates light rays incident thereon strongly. The light transmitted is generally not sufficiently intense to activate an element 202 further down the light path of light rays 203 so that only the first element 202* in each beam path will be activated.

As will be shown below, the size and number density of the elements are in the ranges of approximately 1-1000 μm and approximately 0.1 of the total number density of elements, respectively, in order to provide a desired attenuation.

FIG. 2b illustrates that, whereas the incident bright(est) light ray 203 encounters a continuous wall of highly absorbing light-blocking elements 202*, light ray which are less bright such as light ray 204, encounter a wall with has holes in it thus allowing such lesser bright light rays 204 to pass the optical filter with a higher intensity than the bright(est) light ray 203.

A more detailed description of the invention will now be made with reference to FIGS. 3a and 3b. FIG. 3a shows an illustration of a 3-dimensional version of an optical filter in the form of a substrate sheet 300. In the coordinate system a third axis y, normal to the x-d plane, has been added. The substrate 300 is divided into N_{X}*N_{Y}*N_{D} cells, being the ratios of substrate width, height and depth to chemical element size. As the skilled person will realize, a practical substrate is not formed by discrete orthogonal cells, but for the sake of clarity, a structure as indicated will be used. In typical practical situations there is a substrate depth of approximately 5 mm, substrate area of approximately 20 cm² to 1 m², and light-blocking element radius, rₑₗₑₘₑₙₜ, of approximately 50 μm, leading to N_{D}˜10², N_{X}˜N_{Y}˜10³-10⁴. The total number of cells is N_{T}=N_{X}*N_{Y}*N_{D}˜10⁸-10¹⁰.

FIG. 3b shows a slice 301 of the 301 in the x-d-plane while exposed to light rays 304 incident at angles In FIG. 3b cells/elements are indicated as squares 303. A filled square represents an activated photo-adaptive light-blocking element 302*, a square with four thick borders an inactive photo-adaptive light-blocking element 302, and the remainder of the cells 303 constitute part of the transparent carrier body. N_{E} photo-adaptive elements 302 and 302* are randomly spaced in the substrate, with N_{E}=ρ* N_{T}, where ρ is the number density of the elements. With N_{D}⁻¹<≦ρ≦<1, the number of elements along the substrate depth direction d will be comparatively low, e.g. ρ=N_{D}^{-1/2}=0.1 gives about 10 photo-adaptive elements along a substrate depth direction d. The remaining majority of substrate cells (1−ρ)N_{T} are ‘empty’, containing transparent carrier body material.

In the absence of bright light, all elements are inactive and the substrate is fully transparent in any direction. In the following chain of events, bright light rays, represented by thick arrows 304 in FIG. 3b, are incident on the substrate 301 at an incident angle α_{B} relative to the normal of the carrier body surface.

As mentioned earlier the substrate 300 is divided in a grid of Nₓ* N_{Y}* N_{D} cells, each of which has the dimension of a light-blocking element. The density p of active elements is low, so most cells are ‘empty’ containing only transparent substrate 303. The bright light rays activate some elements, primarily near the surface of light incidence.

When bright light rays 204 reach the slice 301 from an angle xB relative to the depth direction of the substrate, they encounter and activate photo-adaptive light-blocking elements 302 into photo-adaptive elements 302*. The number of activated elements 302*, N_{AE}, equals the frontal substrate surface N_{X}N_{Y} for bright light rays incident perpendicular to the substrate. For α_{B}≠0 it equals the substrate surface S_{B} effectively seen from an angle α_{B}:

N_{AE}=S_{B}=N_{X}N_{Y} cos α_{B} (1)

Each ray will activate the first element it encounters, which is at a randomly distributed depth d. For light passing through a partially absorbing medium, d is distributed according to a standard negative exponential probability. In our case the same holds:

$$λ = \frac{ρ}{cos {α}_{B}} \qquad ( 2 )$$

Both the average μ_{D} and the standard deviation σ_{D} for this distribution equals λ⁻¹.

If the substrate thickness N_{D} is at least a few times, say k=10, the depth standard deviation σ_{D}, all bright light will be blocked fully.

With e.g. ρ=0.1 as before, and taking worst case α_{B}=0, we find that σ_{D}=10, and N_{D}=kσ_{D}=100, justifying our earlier choice of N_{D} at the start of our explanation.

As said before, the light-blocking element radius rₑₗₑₘₑₙₜ should be several times the wavelength of the light to be blocked. More specifically, the length of the “blocking shadow” of each element, equals very roughly the radius squared divided by the wavelength. In order to have other light-blocking elements residing within this shadow, we must have that the radius equals the wavelength divided by ρ and multiplied by a few times, say m=10. This leads to rₑₗₑₘₑₙₜ=wavelength *m *ρ⁻¹. With visible light wavelength of about 0.5 μm, p=0.1, and m=10, we find rₑₗₑₘₑₙₜ˜50 μm, justifying our earlier choice of rₑₗₑₘₑₙₜ at the start of our explanation.

As detailed below, when light rays 305 incident at a direction other direction than α_{B} reach the slice 301, light rays 305 are relatively less blocked than the bright light rays 304. In FIG. 3b such light is represented by the thinner arrows incident at an angle α_{O} with sign opposite to that of α_{B}. Obviously, if α_{O}=α_{B}, the substrate will block the other light as the two types of light cannot be angularly distinguished.

From the direction with angle α_{O}, the substrate has a different effective surface area S_{O}:

S_{O}=N_{X}N_{Y} cos α_{O} (3)

The light rays 305 incident on the substrate 301 can be divided into S_{O} bundles (each of width r). The probability that any of these are blocked depends on the number of photo-activated light-blocking elements S_{B} that such light rays 305 encounter, and is calculated as follows.

The photo-activated light-blocking elements blocking all bright light do not form a continuous flat plane. Instead, because the photo-activated light-blocking elements 302* are not all at the same depth but, e.g. randomly, distributed in the depth direction, the surface formed by the photo-activated light-blocking elements 302* is unevenly-shaped and highly discontinuous. It does however, as previously described, appear as a dense, closed surface when viewed from the angle α_{B}. When viewed from the angle α_{O}, the relative depths between photo-activated light-blocking elements 302* becomes evident by a relative shift in their apparent positions. This shift will cause some of the active photo-activated light-blocking elements 302* to move into the shadow region of other photo-activated light-blocking elements 302* when viewed in the α_{O} direction, thus effectively lowering the number of photo-activated light-blocking elements 302* that can block light in the α_{O} direction.

In order to simplify the calculations, it is possible to choose the x, y coordinates such that x is aligned with the angular α_{B} direction. For an element at position x, y, d, the apparent shift then only has a Δx component. If we take the front plane d=0 of the slice 301 as a reference, the relative shift is:

Δx=d(tan α_{B}−tan α_{O}) (4)

The N_{AE} photo-activated light-blocking elements 302* elements 302* are effectively ‘redistributed’ horizontally in a random fashion guided by d. Since Δx is a scaled version of d, its distribution is similar with deviation:

$${σ}_{Δ x} = \frac{1}{ρ} cos {α}_{B} \vert tan {α}_{B} - tan {α}_{O} \vert \qquad ( 5 )$$

Thus, S_{B} photo-activated light-blocking elements 302* are redistributed to S_{O} positions, with random horizontal displacements Δx with deviation σ_{Δx}. Light rays 305 incident at S_{O} positions that do not have any photo-activated light-blocking elements 302* associated with it will pass the optical filter unblocked.

When σ_{Δx}>1, the positions are effectively randomized, while for σ_{Δx}<1, the positions are effectively the same. This transition occurs at:

$${σ}_{Δ x} = 1 \vert sin {α}_{B} - sin {α}_{O} \frac{cos {α}_{B}}{cos {α}_{O}} \vert = ρ ⇒ \vert {α}_{B} - {α}_{O} \vert \approx ρ \qquad ( 6 )$$

With ρ˜0.1, the transition occurs at about 0.1 rad, corresponding to approx. ˜5.7°, angular difference between bright light rays 304 and other light rays 305. Within angular range [α_{B}−5.7°, α_{B}+5.7°], light rays 305 will be blocked along with the bright light. Light rays 305 outside that angular region will pass the substrate to an extent as follows. From standard statistics it follows that when S_{B} items are randomly assigned to S_{O} boxes, the probability for each box to remain empty is:

$$P = {( 1 - \frac{1}{{S}_{O}} )}^{{S}_{B}} \sim {e}^{- ( \frac{{S}_{B}}{{S}_{O}} )} = {e}^{- ( \frac{cos {α}_{B}}{cos {α}_{O}} )} \qquad ( 7 )$$

This is directly the relative amount of other light passing the substrate in terms of energy. For most angles α_{O} near α_{B}, it yields about P˜e⁻¹˜37%, or −4 dB. For |α_{O}|>|α_{B}|, the ratio becomes worse, e.g. when the bright light is frontal α_{B}=0° and the other light from the side α_{O}=45° we have P˜−6 dB. For |α_{O}|<|α_{B}|, e.g. when driving a car looking straight ahead α_{O}=0° while the sun shines from the side α_{B}=45°, we have P˜−3 dB.

The above shows that for the majority of situations, the bright light is fully blocked while other light is passed with transmissions in the order of −3 to −6 dB. The angular resolution discriminating bright from other light equals p, the density of the active elements in the substrate 300.

There are numerous areas where a substrate 300 as described above can be used advantageously. Obviously the various fields of use sets different demands on the photo-adaptive light-blocking elements in terms of response times.

For sunglasses and automotive windshields the light-blocking elements needs to react quite rapidly in order to conform to the changing ambient conditions.

When the optical filter 300 is used in front of a display unit, to enhance for example the display daylight contrast of a TV-screen or the like, the response time is not necessarily as important since the source of bright light generally will be quite static in relation to the display unit.

FIG. 4 shows a stage in the manufacture of an embodiment of the method in accordance with the invention. FIG. 4 shows a shaped mixture 401 of first transparent particles 402 and photo-adaptive light-blocking elements 403. In this embodiment the particles are spherical, but this is by no means essential, and are made by emulsion or dispersion polymerization and are readily commercially available. FIG. 4 shows a lattice of monodispersive 2 μm PMMA spheres. Monodispersive polymethylmethacrylate (PMMA) spheres are commercially available in sizes varying from tens of nanometers to tens of micrometers. Such spheres are known to pack in well-structured 3D lattices that adapt cubic or hexagonal packing when applied from their dispersion in a liquid non-solvent after evaporation of the liquid component. Well-known examples are opals and photonic crystals that reflect light of well-defined wavelengths. The spheres 402 are blended with a relatively low concentration of PMMA spheres 403 of exactly the same size but loaded with a photo-chromic component (photochromic dye). These photo-adaptive spheres 403 are packed with the unloaded PMMA spheres 402 but are arbitrarily distributed, e.g. randomly or in a grid, in the lattice.

After the mixture of first and second particles has formed in the desired shape, the open spaces present between the spheres are filled with a refractive-index-matching liquid that can be cured. This is needed in order to make the composite as scatter-free and transparent as possible. The index matching curable liquid can be a pre-polymer, such as triethyleneglycol diacrylate (TPDGA), that easily can fill the open spaces present between the spheres. When a photo-initiator (e.g. Irgacure 184—Ciba Specialty Chemicals) is added to this monomeric compound the viscosity is low. When the material has filled the open spaces a brief exposure with UV light, preferably around 260 nm, converts this monomer into a solid polymer with a refractive index of 1.49, equal to that of PMMA.

When exposed to (bright) light the spheres loaded with the photo-chromic components will turn dark. Depending on the concentration of the photo-chromic component and its extinction, the transmission can become very low, the photochromic dye loaded spheres may be photo-adaptive light-blocking elements which substantially block all bright light incident thereon. Photo-chromic dyes are also commercially available, e.g. from PPG Industries and H.W. Sands Corporation, and are already widely applied in sun glasses, though in such cases in contrast to the invention homogeneously dissolved in a polymer matrix. Their response time is typically in the order of seconds to minutes.

Obviously other polymers could also be used, as long as they are transparent and that the resulting refractive index can be matched with the polymer that fills the voids. Examples are polystyrene, polyvinylchloride, polyethylmethacrylate, polyisobomylmethacylate, polymethylacrylate etc. The use of other materials than polymers, having the correct properties, is envisaged.

With the described procedure not only flat screens can be made but also curved optical elements. The curved surface of the curved optical element is provided against the immersed shaped mixture and the liquid is cured while that surface is in contact with that immersed shaped mixture. It is convenient to use a mould, normally consisting of two half elements which are pressed together when filled with the polymer or prepolymer, of which at least one of the surfaces is UV transparent. The mould has the negative shape of the element that will be produced. The spherical particles are deposited on one of the mould surfaces, the TPGDA with photoinitiator is added and the other mould half is brought in place under some pressure. After UV exposure the moulds can be removed. Eventually part of the mould or the whole mould becomes part of the optical element. Besides curved or bended surfaces also more complex surface profiles can be made in this way.

As person skilled in the art appreciates that the above examples are merely illustrative and exemplifying and do not limit the inventive concept as defined by the claims.

1. An optical filter for filtering light rays of a predetermined wavelength and having mutually different light intensity and direction of incidence on the optical filter, the optical filter comprising a carrier body which is transmissive for light rays having the predetermined wavelength and a plurality of photo-adaptive light-blocking elements distributed within the carrier body rendering the optical filter least transmissive in the direction along which the light ray having the highest light intensity is incident.

2. Optical filter according to claim 1, wherein the light-blocking elements are randomly distributed.

3. Optical filter according to claim 1, wherein the light-blocking elements occupy 0.05 to 50% of the combined volume of carrier body and light-blocking elements.

4. Optical filter according to claim 3, wherein the light-blocking elements occupy 0.5 to 15% of the combined volume of carrier body and light-blocking elements.

5. Optical filter according to claim 1, wherein the light-blocking elements are substantially spherical and have a radius in the range of about 1 to 1000 times the predetermined wavelength.

6. Optical filter according to claim 5, wherein the light-blocking elements have a radius in the range of about 10 to 100 times the predetermined wavelength.

7. Optical filter according to claim 1, wherein the light-blocking elements are photochromic.

8. Optical filter according to claim 1, wherein the light-blocking elements comprise a polymer.

9. Optical filter according to claim 8, wherein the polymer contains photochromic material.

10. Optical filter according to claim 7, wherein the polymer is polymethylmethacrylate.

11. A method of manufacturing an optical filter claim 1, comprising:
providing a first quantity of first transparent particles;
providing a second quantity of second transparent particles containing photo-chromic material and mixing said first and second particles, the second quantity being substantially less than the first quantity;
molding the mixture of first and second particles into a shape resembling that of the carrier body;
while maintaining the shape of the shaped mixture of first and second particles, immersing the shaped mixture of first and second particles into a curable liquid having, in its cured state, a refractive index which matches that of the first particles;
while maintaining the shape of the shaped mixture of first and second particles, curing the curable liquid.

12. Method according to claim 11, wherein the first and second particles comprise a polymer.

13. Method according to claim 12, wherein the spheres comprise polymethylmethacrylate.

14. Method according to claim 11, wherein the shaped mixture of first and second particles is molded against the surface of a product with which the optical filter is to be combined.

15. Method according to claim 11, wherein the curable liquid is photo-curable and the curing is performed using ultraviolet light.

16. (canceled)
